(19) United States
(12) Patent Application Publication
(10) Pub. No.: US 2021/0405758 A1
(43) Pub. Date: Dec. 30, 2021

(54) METHOD OF CONTROLLING AUGMENTED REALITY ELECTRONIC DEVICE

(71) Applicant: LG ELECTRONICS INC., Seoul (KR)

(72) Inventors: Doyeon KIM, Seoul (KR); Seunghyun KIM, Seoul (KR); Hyejin KIM, Seoul (KR); Dahye YOON, Seoul (KR); Sukmin LEE, Seoul (KR)

(73) Assignee: LG ELECTRONICS INC., Seoul (KR)

(21) Appl. No.: 16/491,821

(22) PCT Filed: Jun. 5, 2019
(86) PCT No.: PCT/KR2019/006795

§ 371 Date: Sep. 6, 2019

(51) Int. Cl. G06F 3/01; G06F 3/0481; G02B 27/01

(52) U.S. Cl. CPC G06F 3/017; G06F 3/011; H04W 72/1289; G02B 27/0172; G06F 3/04817

(57) ABSTRACT

A method of controlling an augmented reality (AR) electronic device worn on a head part of a user. The method comprising allocating a display area within a visual field of a user and displaying a virtual object in the display area, obtaining motion information on the basis of a hand image of a user using an image capturing unit, calculating coordinates of a pointer from the motion information and displaying the pointer in the display area, separately displaying a real object and a virtual object not to overlap each other if the pointer is located in an area where the real object and the virtual object overlap each other in the visual field of the user.

### TECHNICAL FIELD

The present disclosure relates to a method of controlling an augmented reality (AR) electronic device, and more particularly, to a method of controlling an AR electronic device which controls a user interface more intuitively.

### BACKGROUND ART

Augmented reality (AR) is a technology of displaying virtual objects on an image or background of reality in an overlapping manner. Unlike virtual reality (VR) technology in which objects, backgrounds, and environments are all formed of virtual images, the AR technology mixes virtual objects with a real environment to provide users with more realistic additional information in the real environment. For example, when a user, who goes on the street, illuminates the surroundings with a camera of a digital device, the user may be provided with information of a building, road information, and the like included in an image collected by the camera. Such an AR technology has come to prominence as portable devices have recently become prevalent.

In order to enhance portability and convenience of the AR electronic device, a method of easily controlling a user interface (UI) is required to be used.

For example, in order to control a UI of an AR electronic device of a related art, it is necessary to obtain a new control method or the UI is not intuitive in many cases.

Meanwhile, a characteristic of displaying real and virtual objects at the same time is not reflected to cause inconvenience in controlling a UI. In particular, when a real object and a virtual object overlap, a user may have difficulty in selecting a specific object.

### DISCLOSURE

### Technical Problem

The present disclosure aims at solving the above-mentioned problems.

An embodiment of the present disclosure provides an augmented reality control method for controlling a UI intuitively.

Furthermore, an embodiment of the present disclosure provides a method of controlling an augmented reality electronic device, which allows a user to easily select a specific object even when a real object and a virtual object overlap each other.

### Technical Solution

Furthermore, in this specification, a method of controlling an augmented reality (AR) electronic device includes: allocating a display area within a visual field of a user and displaying a virtual object in the display area; obtaining motion information on the basis of a hand image of a user using an image capturing unit; calculating coordinates of a pointer from the motion information and displaying the pointer in the display area; and separately displaying a real object and a virtual object not to overlap each other if the pointer is located in an area where the real object and the virtual object overlap each other in the visual field of the user.

According to an embodiment of the present disclosure, the separately displaying of the real object and the virtual object may include displaying an emoticon or a user interface corresponding to the real object.

According to an embodiment of the present disclosure, the method may further include generating a predetermined event according to the motion information. The generating of a predetermined event may include generating an idle event if a thumb and a middle finger are separated and a degree to which four fingers excluding the thumb are bent is less than a predetermined first threshold value in the motion information.

According to an embodiment of the present disclosure, the method may further include generating a predetermined event according to the motion information. The generating of a predetermined event may include generating a first event if a thumb is in contact with a middle finger, a degree to which an index finger is bent is less than a predetermined first threshold value, and a degree to which a middle finger, a ring finger, and a little finger are bent is equal to or greater than the first threshold value in the motion information.

According to an embodiment of the present disclosure, the method may further include performing a motion corresponding to a mouse left click according to the first event.

According to an embodiment of the present disclosure, the performing of a specific motion according to the first event may include performing another motion depending on a position where the thumb is in contact with the middle finger.

According to an embodiment of the present disclosure, the method may further include generating a predetermined event according to the motion information. The generating of a predetermined event may include generating a second event if a thumb and a middle finger are separated, a degree to which an index finger is less than a predetermined first threshold value, and a degree to which a middle finger, a ring finger and a little finger are bent is equal to or greater than the first threshold value in the motion information.

According to an embodiment of the present disclosure, the method may further include performing a motion corresponding to a mouse release according to a second event.

According to an embodiment of the present disclosure, the obtaining of motion information may include obtaining pointer coordinates corresponding to a predetermined specific position in the hand image.

According to an embodiment of the present disclosure, the method may further include displaying a user interface of a virtual object or a real object corresponding to a point indicated by the pointer.

According to an embodiment of the present disclosure, the method may further include generating a third event if a motion of the thumb sliding on the middle finger is identified in the first event state, in which the third event is performing a control operation of the user interface.

According to an embodiment of the present disclosure, the method may further include generating a fourth event if a motion of the index finger is identified in the first event state. The fourth event may be performing a control operation of the user interface.

According to an embodiment of the present disclosure, the method may further include adding a feedback effect for enhancing visibility of the user interface indicated by the pointer.

According to an exemplary embodiment of the present disclosure, the displaying of a pointer may include sequentially varying a pointer position over time, and if the hand image is blurred at a specific point of time, the pointer for the blurred hand image may be displayed by interpolating the pointer position generated on the basis of a few or more previous time points.

### Advantageous Effects

The present disclosure may provide a more intuitive AR control method because a UI may be controlled on the basis of a mouse click operation familiar to the user.

Also, in the present disclosure, when a real object and a virtual object overlap, the real object and the virtual object are separately displayed, and thus, a specific object may be more conveniently selected.

Also, in the process of separating the real object and the virtual object, the real object is indicated by a corresponding UI, and thus, the UI may be controlled quickly.

### DESCRIPTION OF DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 is a conceptual view of AR electronic device according to an embodiment of the present disclosure.

FIG. 5 is a block diagram of augmented reality (AR) electronic device in accordance with the present disclosure.

FIG. 6 is a block diagram of an AI device according to an embodiment of the present disclosure.

FIG. 7 is a flowchart illustrating a method of controlling an augmented reality (AR) electronic device according to an embodiment of the present disclosure.

FIG. 8 is a view illustrating a method of obtaining motion information.

FIGS. 9 to 13 are views illustrating events corresponding to motion information.

FIG. 14 is a view illustrating a method of controlling an AR electronic device according to another embodiment of the present disclosure.

FIGS. 15 and 16 are views illustrating a specific embodiment of a method of controlling an AR electronic device.

FIGS. 17A to 18B are views illustrating an embodiment of a method of controlling a user interface (UI) using a drag motion.

FIGS. 19 and 20 are views illustrating an embodiment of a method of controlling a UI using a combination of a click/release motion and a drag motion.

FIG. 21 is a view illustrating an embodiment of a method of controlling a UI according to a click position.

FIG. 22 is a view illustrating an embodiment of inputting letters to a keyboard UI.

FIG. 23 is a view illustrating an embodiment of a feedback effect for informing a user of a position of a pointer.

FIGS. 24 and 25 are views illustrating an additional embodiment of determining a position of a pointer.

FIG. 26 is a view illustrating a method of obtaining motion information from a plurality of hand-shaped images.

FIG. 27 is a view illustrating an embodiment of interpolating a blurred image when an image blur phenomenon occurs.

### MODE FOR DISCLOSURE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Hereinafter, 5G communication (5th generation mobile communication) required by an apparatus requiring AI processed information and/or an AI processor will be described through paragraphs A through G

A. Example of Block Diagram of UE and 5G Network

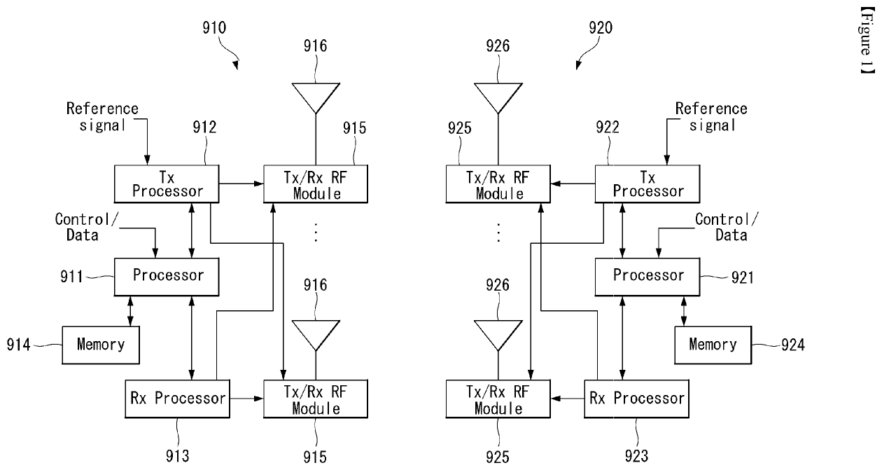

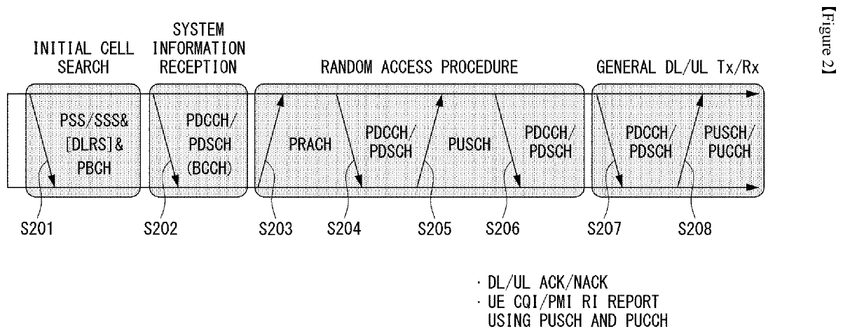

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

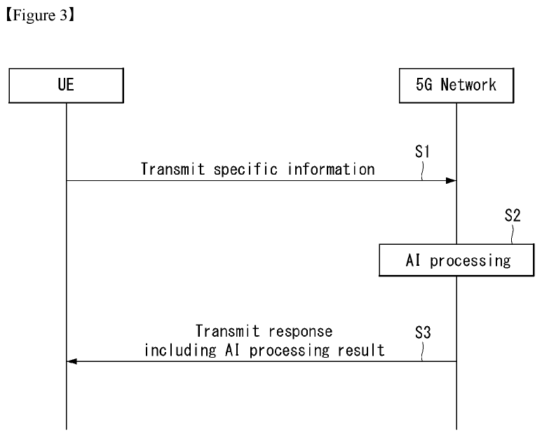

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Processing Using 5G Communication

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE (S3).

G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

Augmented Reality (AR) Electronic Device

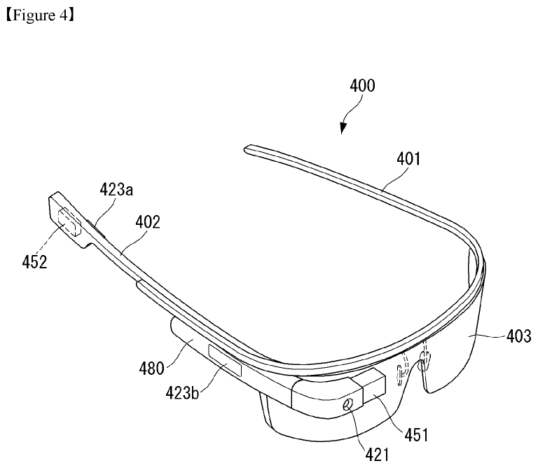

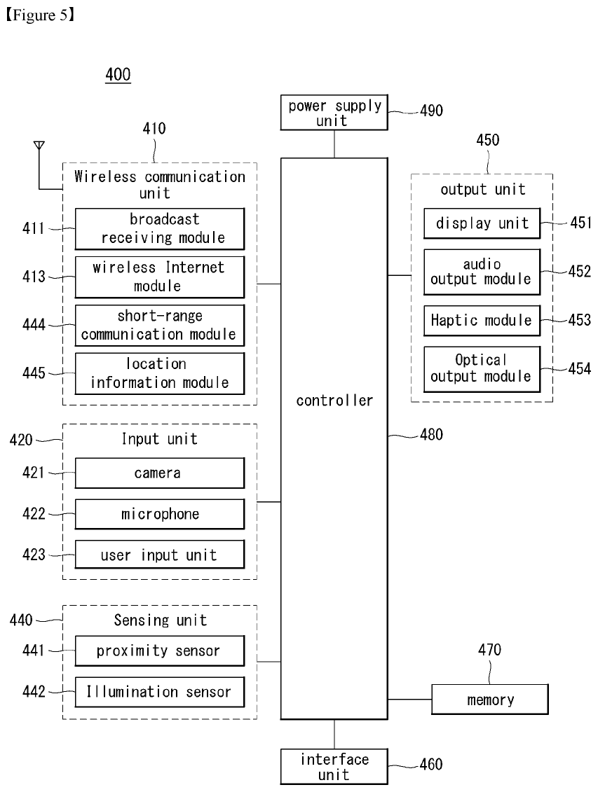

FIG. 4 is a perspective view of an AR electronic device according to an embodiment of the present disclosure. FIG. 5 is a view illustrating a configuration of an AR electronic device according to an embodiment of the present disclosure.

Referring to FIG. 4, a glass type mobile terminal 400 may be configured to be worn on a head of a human body and may include a frame part (case, housing, etc.) 101 therefor. The frame part may be formed of a flexible material to facilitate wearing. In the drawing, the frame part is illustrated to include a first frame 401 and a second frame 402 formed of different materials.

The frame part 101 is supported on the head and provides a space in which various components are mounted. As illustrated, electronic components such as a controller 480, an audio output unit 402, and the like may be mounted in the frame part 101. Further, a lens 403 covering at least one of a left eye and a right eye may be detachably mounted on the frame part.

The controller 480 is configured to control various electronic components provided in the mobile device 400. In the drawing, the controller 480 is illustrated to be installed in the frame part on one side of the head. However, the position of the controller 103 is not limited thereto.

The display unit 451 may be implemented as a head-mounted display (HMD) type. The HMD type is a display scheme mounted on the head part and showing an image directly in front of the user's eyes. When the user wears the glass type mobile terminal 400, the display unit 451 may be disposed to correspond to at least one of the left eye and the right eye to provide an image directly in front of the user's eyes. In the drawing, the display unit 451 is illustrated to be positioned at a portion corresponding to the right eye so that an image may be output toward the right eye of the user.

The display unit 451 may project an image to a display area using a prism. Further, the prism may be formed to be translucent so that the user may see the projected image together with a general field of view (a range the user sees through the eye) together.

As such, the image output through the display unit 451 may appear to overlap the general field of view. The mobile terminal 400 may provide augmented reality (AR) that displays a single image by superimposing a virtual image on a real image or a background using such characteristics of the display.

An image capturing unit 421 is disposed adjacent to at least one of the left eye and the right eye and captures an image of a front side. Since the image capturing unit 421 is positioned adjacent to the eye, the image capturing unit 421 may obtain a scene viewed by the user as an image.

In this drawing, the image capturing unit 421 is illustrated to be included in the control module 480 but is not necessarily limited thereto. The image capturing unit 421 may be installed in the frame part or may be provided in plurality to obtain a stereoscopic image.

The glass type mobile terminal 400 may include user input units 423a and 423b operated to receive a control command. The user input units 423a and 423b may employ any scheme as long as it is operated while the user has a tactile sense such as a touch or a push. In the drawing, the user input units 423a and 423b based on the push and touch input scheme are provided in the frame part and the control module 480, respectively.

Further, the glass-type mobile terminal 400 may include a microphone for receiving sound and processing it as electrical voice data and an audio output unit 452 for outputting sound. The audio output unit 452 may be configured to transfer sound according to a general sound output method or a bone conduction method. If the audio output unit 452 is implemented in the bone conduction manner, when the user wears the mobile terminal 400, the audio output unit 452 is in close contact with the head and vibrates a skull to transmit sound

Referring to FIG. 5, the AR electronic device 400 may include a wireless communication unit 410, an input unit 420, a sensing unit 440, an output unit 450, an interface unit 460, a memory 470, a controller 480, and a power supply unit 490. The components illustrated in FIG. 5 are not a requirement to implement the mobile terminal and the mobile terminal described in this disclosure may have greater or fewer components.

Specifically, among the components, the wireless communication unit 410 typically includes one or more modules enabling wireless communication between the AR electronic device 400 and a wireless communication system, between the AR electronic device 400 and another AR electronic device 400, or between the AR electronic device 400 and an external server. Also, the wireless communication unit 410 may include at least one module connecting the AR electronic device 400 to one or more networks.

The wireless communication unit 410 may include at least one of a broadcast receiving module 411, a mobile communication module 412, a wireless internet module 413, a short-range communication module 414, and a location information module 415.

The input unit 420 may include a camera 421 or an image input unit for inputting an image signal, a microphone 422 or an audio input unit for inputting an audio signal, a user input unit 423 (e.g., a touch key, a mechanical key, etc.) for receiving information from a user. Voice data or the image data collected by the input unit 420 may be analyzed and processed as a control command of the user.

The sensing unit 440 may include one or more sensors configured to sense internal information of the mobile terminal, information of a surrounding environment of the mobile terminal, and user information. For example, the sensing unit 440 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (e.g., refer to the image capturing unit 421), a microphone 422, a battery gauge, an environment sensor (e.g., a barometer, a hygrometer, a thermometer, a radiation detection sensor, a thermal sensor, and a gas sensor, etc.), and a chemical sensor (e.g., an electronic nose, a health care sensor, a biometric sensor, etc). The mobile terminal 100 may utilize a combination of pieces of information sensed by at least two of the sensors.

The output unit 450, which is serves to generate an output related to visual, auditory, or tactile senses, may include at least one of the display unit 451, the audio output unit 452, a haptic module 453, and an optical output unit 454. The display unit 451 may have an inter-layered structure or integrally formed with a touch sensor to implement a touch screen. The touch screen may function as a user input unit 423 that provides an input interface between the AR electronic device 400 and the user and may provide an output interface between the AR electronic device 400 and the user

The interface unit 460 serves as an interface with various types of external devices connected to the AR electronic device 400. The interface unit 460 may include at least one of wired or wireless ports, external charger ports, wired/wireless data ports, memory card ports, ports for connecting a device having an identification module, audio input/output (I/O) ports, video I/O ports, and earphone ports. When an external device is connected to the interface unit 460, the AR electronic device 400 may perform appropriate control related to the connected external device.

In addition, the memory 470 stores data supporting various functions of the AR electronic device 400. The memory 470 may store a plurality of application programs (or applications) driven by the AR electronic device 400, data for operation of the AR electronic device 400, and instructions. At least some of these applications may be downloaded from an external server via wireless communication. In addition, at least some of these applications may be provided in the AR electronic device 400 from a time of release for basic functions of the AR electronic device 400 (e.g., call incoming, call outgoing, message receiving, message sending). The application program may be stored in the memory 470 and installed on the AR electronic device 400 and may be driven by the controller 480 to perform an operation (or function) of the mobile terminal.

In addition to the operation related to the application program, the controller 480 generally controls an overall operation of the AR electronic device 400. The controller 480 may provide or process information or a function appropriate to the user by processing signals, data, information, and the like, which are input or output through the components described above or by driving an application program stored in the memory 470.

In addition, the controller 480 may control at least some of the components described above with reference to FIG. 5 in order to drive an application program stored in the memory 470. In addition, the controller 480 may operate a combination of at least two of the components included in the AR electronic device 400 to drive the application program.

The power supply unit 490 receives external power or internal power under the control of the controller 480 to supply power to each component included in the AR electronic device 400. The power supply unit 490 may include a battery, and the battery may be an internal battery or a replaceable battery.

At least some of the above components may operate in cooperation with each other to implement an operation, control, or control method of the mobile terminal according to various embodiments described below. In addition, the operation, control, or control method of the mobile terminal may be implemented on the mobile terminal by driving at least one application program stored in the memory 470.

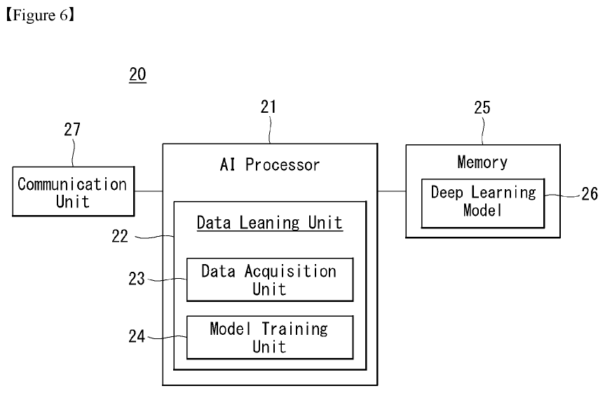

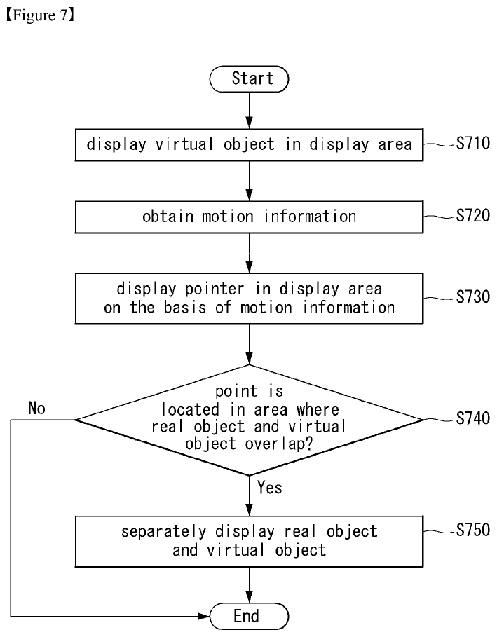

FIG. 6 is a block diagram of an AI device according to an embodiment of the present disclosure.

Referring to FIG. 6, an AI device 20 may include an electronic device including an AI module that can perform AI processing, a server including the AI module, or the like. Further, the AI device 20 may be included as at least one component of the AR electronic device 400 shown in FIG. 4 to perform together at least a portion of the AI processing.

The AI processing may include all operations related to driving of the AR electronic device 400 shown in FIG. 4. For example, an AR electronic device 400 can perform operations of processing/determining, and control signal generating by performing AI processing on sensing data or driver data. Further, for example, an AR electronic device 400 can perform autonomous driving control by performing AI processing on data acquired through interaction with other electronic devices included in the vehicle.

The AI device 20 may include an AI processor 21, a memory 25, and/or a communication unit 27.

The AI device 20, which is a computing device that can learn a neural network, may be implemented as various electronic devices such as a server, a desktop PC, a notebook PC, and a tablet PC.

The AI processor 21 can learn a neural network using programs stored in the memory 25. In particular, the AI processor 21 can learn a neural network for recognizing data related to vehicles. Here, the neural network for recognizing data related to vehicles may be designed to simulate the brain structure of human on a computer and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present disclosure.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by acquiring learning data to be used for learning and by applying the acquired learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data acquiring unit 23 and a model learning unit 24.

The learning data acquiring unit 23 can acquire learning data required for a neural network model for classifying and recognizing data. For example, the learning data acquiring unit 23 can acquire, as learning data, vehicle data and/or sample data to be input to a neural network model.

The model learning unit 24 can perform learning such that a neural network model has a determination reference about how to classify predetermined data, using the acquired learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 24 can use learning data acquired for learning for image recognition.

Further, the learning data selector can select data for learning from the learning data acquired by the learning data acquiring unit 23 or the learning data preprocessed by the preprocessor. The selected learning data can be provided to the model learning unit 24. For example, the learning data selector can select only data for objects included in a specific area as learning data by detecting the specific area in an image acquired through a camera of a vehicle.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs control related to autonomous driving.

Meanwhile, the AI device 20 shown in FIG. 6 was functionally separately described into the AI processor 21, the memory 25, the communication unit 27, etc., but it should be noted that the aforementioned components may be integrated in one module and referred to as an AI module.

Method of Controlling Augmented Reality Electronic Device

FIG. 7 is a flowchart illustrating a method of controlling an augmented reality (AR) electronic device according to an embodiment of the present disclosure.

Referring to FIG. 7, in a method for controlling an AR electronic device according to an embodiment of the present disclosure, a virtual object is displayed in a display area in a first step S710. The display area may be defined as an area in which light emitted from the display unit 451 passes through the glass 403. The virtual object refers to an image received from an operated application.

In a second step S720, motion information is obtained. The motion information is information extracted from a hand image of a user. The controller 480 obtains motion information on the basis of positions and shapes of the fingers from the hand image.

In a third step S730, a pointer is displayed on the display area. The pointer, which is used to distinguish a specific object to be controlled, is displayed within the display area. The controller 480 may obtain pointer coordinates from the motion information. The controller 480 may obtain the pointer coordinates corresponding to a specific position of the hand image, for example, a tip position of an index finger. The pointer coordinates are matched to a position where the pointer is to be displayed in the display area.

In a fourth step S740 and a fifth step S750, the controller 480 determines whether the pointer is located in an area where a real object and a virtual object overlap each other.

If the pointer is located in the area where the real object and the virtual object overlap each other, the controller 480 separately displays the real object and the virtual object.

Hereinafter, the details of each step will be described in the following embodiments.

The method of controlling an AR electronic device according to an embodiment of the present disclosure is performed on the basis of motion information of a user.

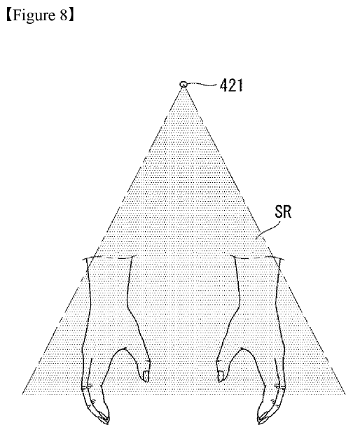

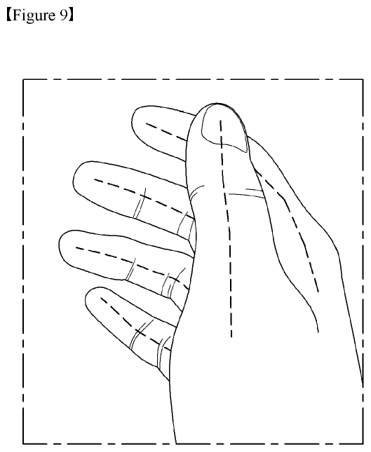

FIG. 8 is a view illustrating a method of obtaining motion information.

Referring to FIG. 8, the image capturing unit 421 may obtain the hand image of the user, and the controller 480 may obtain motion information from the hand image. The motion information refers to a position and a shape of each of the fingers of the user. In particular, according to an embodiment of the present disclosure, the motion information may generate an event corresponding to a mouse function, which is an input device of a computer.

FIGS. 9 to 13 are views illustrating events corresponding to motion information.

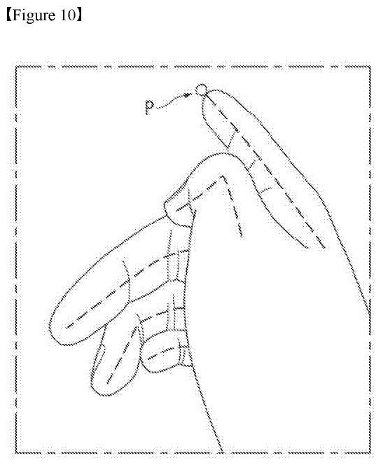

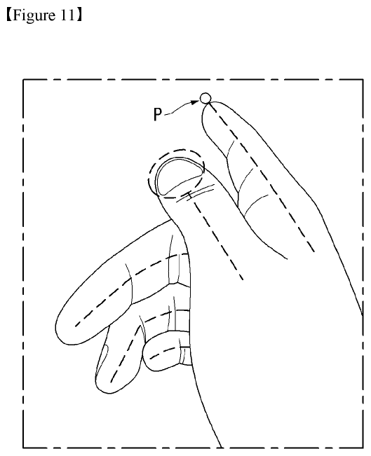

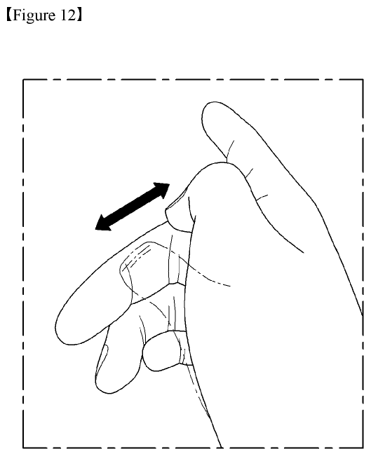

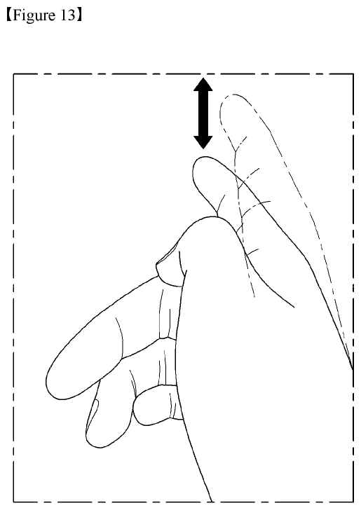

FIG. 9 is a view illustrating motion information in an idle state (i.e., waiting state or standby state) without event generation, and FIGS. 10 and 11 are views illustrating motion information for generating a click/release event, respectively. FIGS. 12 and 13 are views illustrating motion information for generating a drag event.

In FIGS. 9 to 13, in order to determine a degree of bending each finger (i.e., a degree to which each finger is bent), the controller 480 may estimate skeleton information connecting nodes of the fingers in the hand image. The degree of bending each finger may be determined on the basis of an angle between skeleton information between a second node and a knuckle and skeleton information corresponding to a back of the hand.

Referring to FIG. 9, motion information corresponding to the idle state is a state in which five fingers are not significantly bent and four fingers excluding a thumb are in a similar state of bending.

The controller 480 generates an event of an idle state according to motion information that the thumb and the index finger are spaced apart from each other and a degree of bending four fingers excluding the thumb is less than a predetermined first threshold value.

Referring to FIG. 10, motion information corresponding to a click event is in a state in which the index finger is straightened and the four fingers excluding the index finger are bent. In particular, a part of the thumb is in contact with a middle finger.

The controller 480 generates a click event according to the motion information that the thumb and the middle finger are in contact with each other, a degree of bending the index finger is less than the predetermined first threshold value and a degree of bending the middle finger, a ring finger, and a little finger is equal to or greater than the first threshold value.

Referring to FIG. 11, motion information corresponding to a release event is the same as a click event in the four fingers excluding the thumb. The thumb is straightened and spaced apart from the middle finger.

The controller 480 generates a release event if the thumb and the middle finger are spaced apart from each other, a degree of bending the index finger is less than the predetermined first threshold value, and a degree of bending the middle finger, the ring finger, and the little finger is equal to or greater than the first threshold value.

Referring to FIGS. 12 and 13, the degree of bending of each of the fingers in the motion information corresponding to a drag event is the same as the motion information of the click event shown in FIG. 10. The drag event corresponds to a motion of moving the thumb or the middle finger in a click event state. For example, as shown in FIG. 12, a motion of sliding the thumb on the middle finger corresponds to a horizontal drag motion. Alternatively, as shown in FIG. 13, a motion of vertically moving the index corresponds to a vertical drag motion.

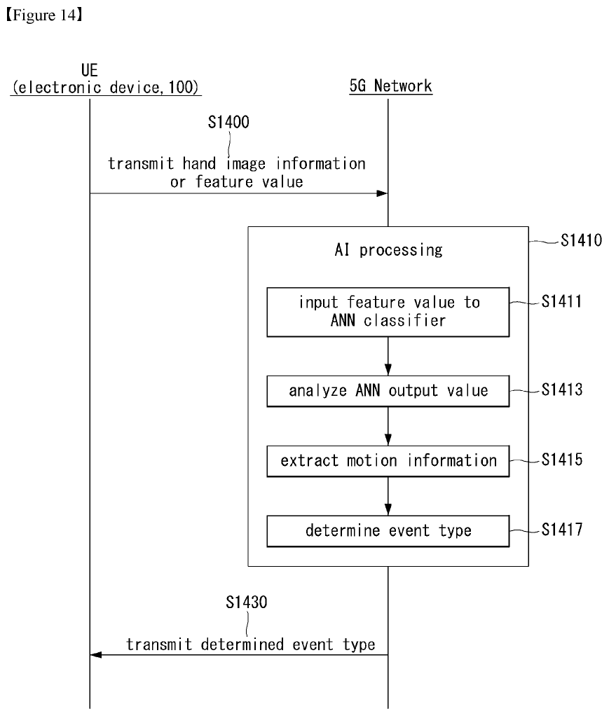

FIG. 14 is a view illustrating another embodiment of obtaining an event corresponding to motion information.

The controller 380 may control the communication unit to transmit the hand image information obtained by the AR electronic device 400 to the AI processor included in a 5G network. In addition, the controller 380 may control the communication unit to receive AI-processed information from the AI processor.

The AI-processed information may be event information obtained from the hand image information.

Meanwhile, the AR electronic device 400 may perform an initial access procedure with a 5G network in order to transmit the hand image information to the 5G network. The AR electronic device 400 may perform an initial access procedure with the 5G network on the basis of a synchronization signal block (SSB).

Also, the AR electronic device 400 may receive downlink control information (DCI) from the network, which is used for scheduling transmission of the hand image information through a wireless communication unit.

The processor 170 may transmit the hand image information to the network on the basis of the DCI.

The hand image information may be transmitted to the network through a PUSCH, and the SSB and a DM-RS of the PUSCH may be quasi-co-located, QCL, for a QCL type D.

Referring to FIG. 14, the AR electronic device 400 may transmit feature values extracted from the hand image information to the 5G network (S1400).

Here, the 5G network may include an AI processor or an AI system, and the AI system of the 5G network may perform AI processing on the basis of the received sensing information (S1410).

The AI system may input the feature values received from the AR electronic device 400 to the ANN classifier (S1411). The AI system may analyze an ANN output value (S1413) and determine motion information regarding the hand image from the ANN output value (S1415). The AI system may determine an event type on the basis of the motion information.

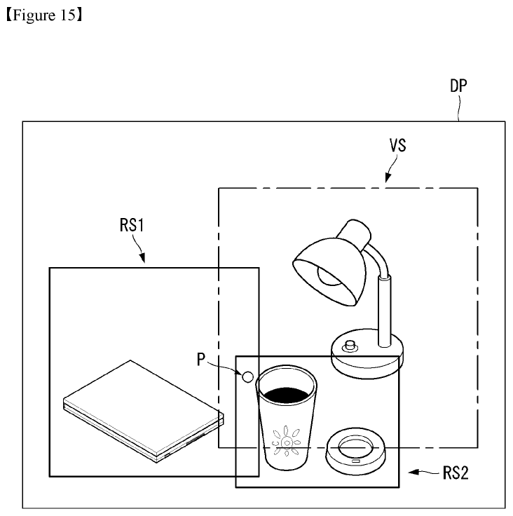

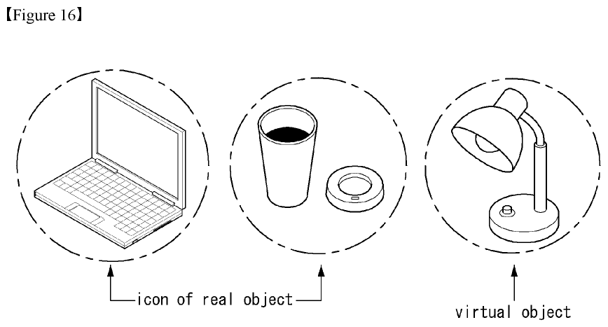

The 5G network may transmit the event type information determined by the AI system to the AR electronic device 400 through the wireless communication unit (S1430). FIGS. 15 and 16 illustrate an embodiment of a method of controlling an AR electronic device.

FIG. 15 is a view illustrating an example of an image displayed in a display area.

Referring to FIG. 15, a display area DP displays a real object and a virtual object at the same time. A pointer P is displayed as instructed by the index finger of the user in the motion information. The pointer P may be displayed in any area of the display area DP. When the pointer P is located in the area where only the virtual object VS is displayed, a user interface (UI) corresponding to the virtual object VS may be displayed. When the pointer P is located in the area where only a first real object RS1 or a second real object RS2 is displayed, a UI corresponding to each real object may be displayed.

However, in a case where the pointer P is located in an area where two or more objects overlap each other as shown in FIG. 15, it is difficult to display a UI of a specific object. The user may move the pointer P to display a UI of a desired object, but since the area of the second real object RS2 that does not overlap other objects is very small, it is difficult to move the pointer P to a corresponding position.

According to an embodiment of the present disclosure, when the pointer P is located in the area where objects overlap each other, the controller 480 separately displays the overlapping objects.

FIG. 16 is a view illustrating an embodiment in which objects in overlapping areas are displayed.

Referring to FIG. 16, in the case where the pointer P is located in the area where the plurality of objects overlap as shown in FIG. 15, the controller 480 separately displays each object. In other words, the controller 480 displays the corresponding objects not to overlap each other.

The controller 480 may change the images of the objects in the process of separating the objects. For example, since the real objects RS1 and RS2 correspond to the images obtained through the image capturing unit, it is difficult to provide an intuitive UI. The controller 480 learns the real objects and analyzes types of objects on the basis of the learned real objects. The controller 480 may display icons or UIs corresponding to the types of the real objects on the basis of learning results.

Hereinafter, embodiments of a method for controlling a UI using motion information will be described.

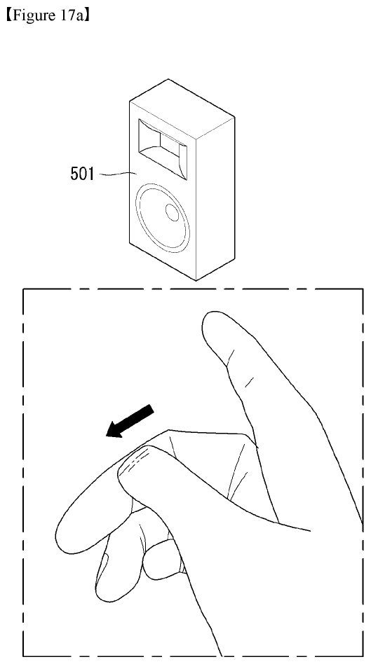

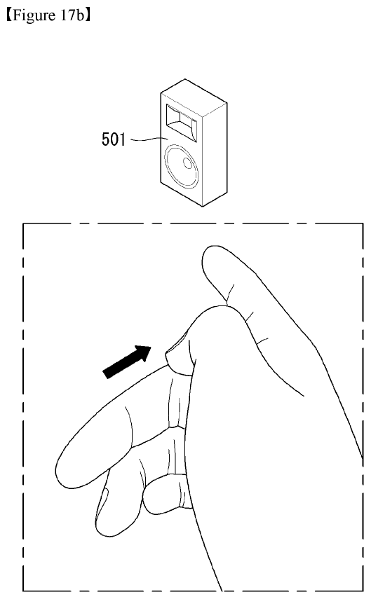

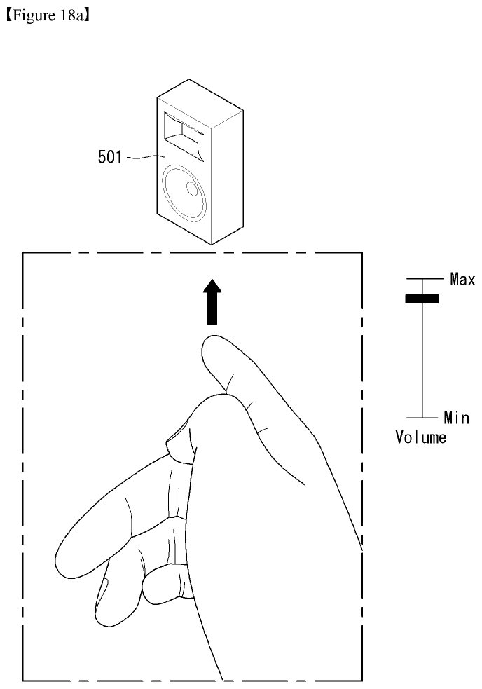

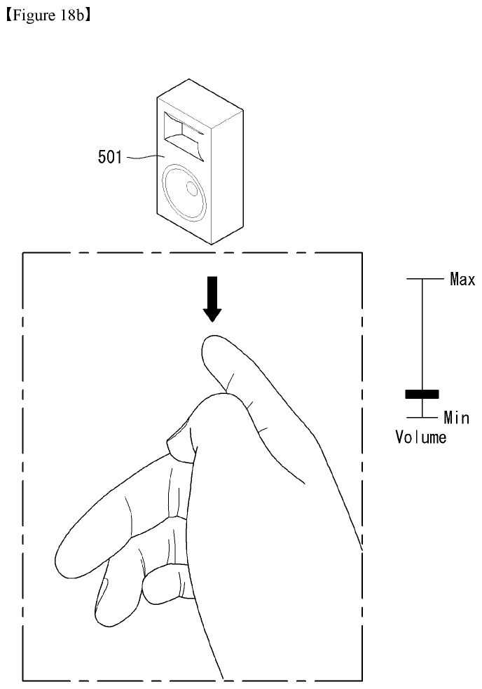

FIGS. 17A to 18B are views illustrating an embodiment of a method of controlling a UI using a drag motion. FIGS. 17A to 18B illustrate an embodiment of a UI of an amplifier selected by motion information.

FIGS. 17A and 17B illustrate a case where an event is generated in which a horizontal drag motion is successively performed in a click motion state. The controller 480 may adjust a size of an amplifier UI 501 when the horizontal drag motion is performed in the click motion state. As shown in FIG. 17A, when the thumb is dragged to the left, the controller 480 may increase the size of the amplifier UI 501. Alternatively, when the thumb is dragged to the right, the controller 480 may reduce the size of the amplifier UI 501.

FIGS. 18A and 18B are views illustrating an event in which a vertical drag motion is successively performed in a click motion state.

Referring to FIGS. 18A and 18B, when the vertical drag motion is performed in the click motion state, the controller 480 may control content of the amplifier UI 501. The content control of the amplifier UI 501 may be volume control. As shown in FIG. 18A, when the index finger is dragged upwards, the controller 480 may turn up the volume of the amplifier. If the index finger is dragged downwards, the controller 480 may turn down the volume of the amplifier.

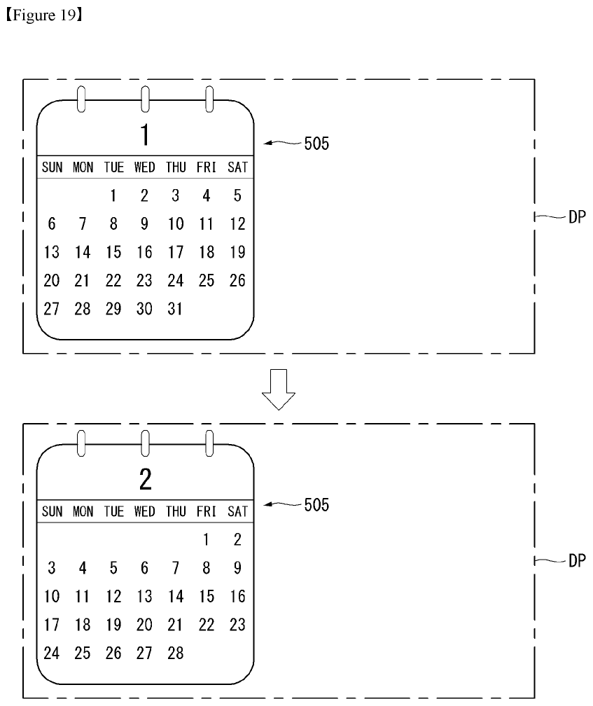

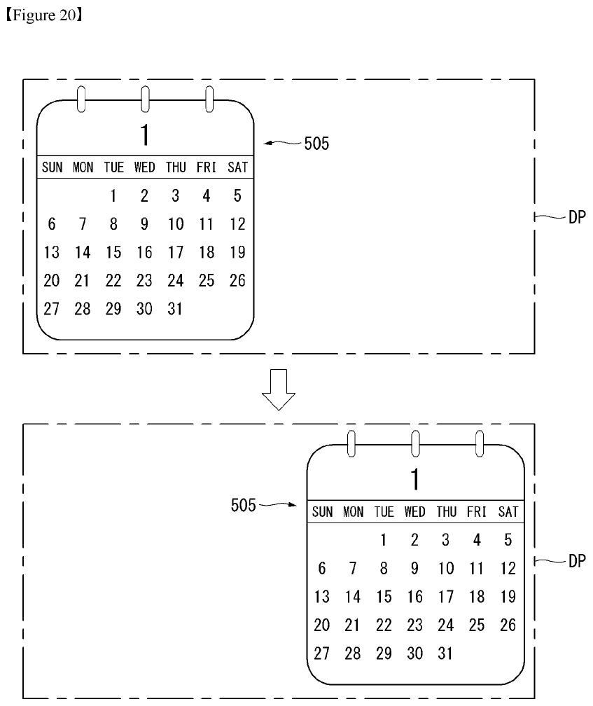

FIGS. 19 and 20 are views illustrating an embodiment of a method of controlling a UI using a combination of a click/release motion and a drag motion. FIGS. 19 and 20 illustrate an embodiment of a calendar UI for schedule management, in particular, a monthly calendar.

Referring to FIG. 19, when it is detected that a drag motion is performed in a state in which click and release motions are continuously performed, the controller 480 generates a content change event. The controller 480 changes the content of the UI according to a first event. Changing the content of the UI may be defined as changing “month” of the calendar. For example, a calendar UI 505 displaying “January” may display “February” according to the content change event.

Referring to FIG. 20, the controller 480 generates a position movement event by performing a drag motion in a click state. The controller 480 may change a position of the calendar UI 505 according to a second event. For example, the controller 480 may control the calendar UI 505 to be moved in a drag direction within the display area DP.

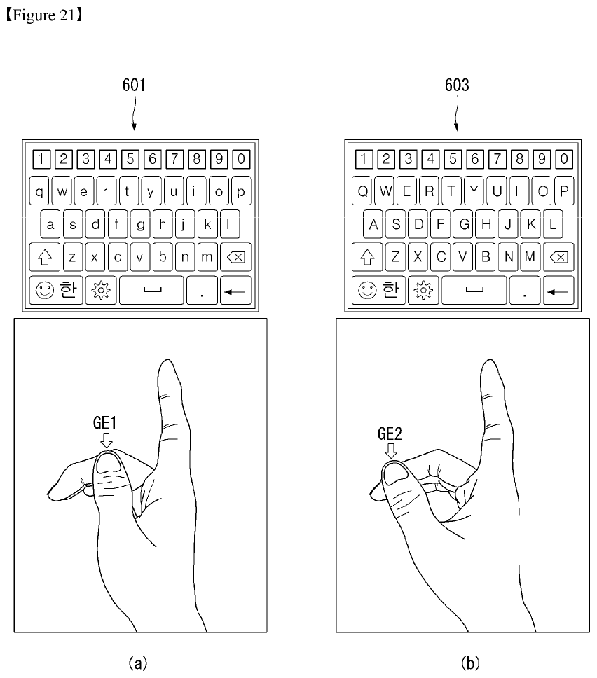

FIG. 21 is a view illustrating an embodiment of a method of controlling a UI according to a click position.

Referring to FIG. 21, the controller 480 distinguishes between events according to click positions. For example, the controller 480 distinguishes between events according to a first position GE1 in which the thumb is in contact with a second node of the middle finger or according to a second position GE2 in which the thumb is in contact with a first node of the middle finger.

When it is determined that the thumb is in the first position GE1 as illustrated in (a) of FIG. 21, the controller 480 displays a general keyboard UI 601 in the display area DP.

When it is determined that the thumb is in the second position GE2 as shown in (b) of FIG. 21, the controller 480 displays an upper case keyboard UI 603 or the double-consonant keyboard UI in the display area DP.

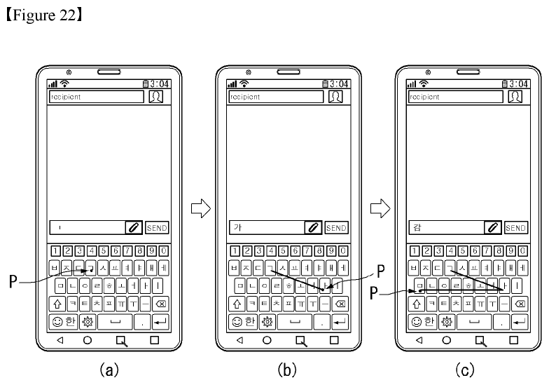

FIG. 22 is a view illustrating an embodiment of inputting letters to a keyboard UI.

Referring to (a) of FIG. 22, the controller 480 may input a spelling of the keyboard where the pointer is located according to motion information. For example, if the pointer P indicates a key of “ [symbol] ”, the controller 480 displays “ [symbol] ” in an input window.

Referring to (b) of FIG. 22, when the pointer P moves quickly at a predetermined speed or higher, inputting of a spelling of the keyboard indicated by the pointer P is omitted. Also, a spelling of the keyboard corresponding to a position where the pointer P stays for a predetermined time or longer is input. For example, if the pointer P moves at a high speed from the key “ [symbol] ” to a key “ [symbol] ” and stops at the key “ [symbol] ” on the keyboard, the controller 480 displays “ [symbol] ”.

Referring to (c) of FIG. 22, if the pointer P moves at a high speed from the key “ [symbol] ” to a key “ [symbol] ” on the keyboard, the controller 480 displays “ [symbol] ” in the input window.

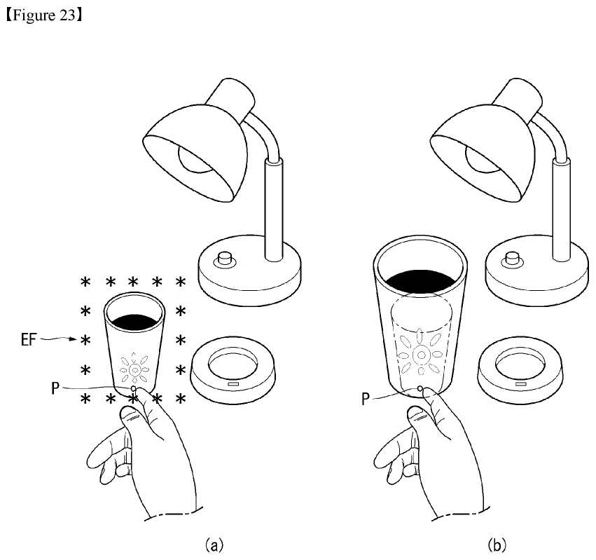

FIG. 23 is a view illustrating an embodiment of a feedback effect for informing a user of a position of a pointer.

Since the position of the pointer P is displayed in the display area, the user may check it. However, since the pointer itself has poor visibility, the controller 480 may provide a feedback effect to an object corresponding to the position of the pointer.

Referring to (a) of FIG. 23, the controller 480 may display an edge effect EF on an outer portion of an object indicated by the pointer P. The edge effect EF surrounds the edges of the object and may add a sparkling effect to better visibility.

Referring to (b) of FIG. 23, the controller 480 may increase visibility by displaying the size of the object indicated by the pointer P larger.

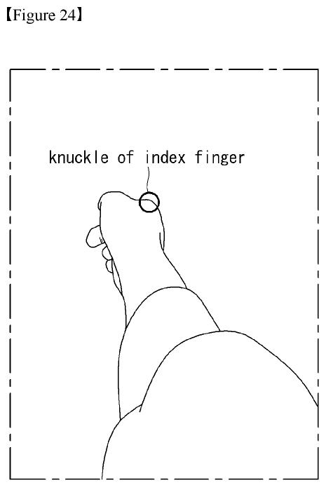

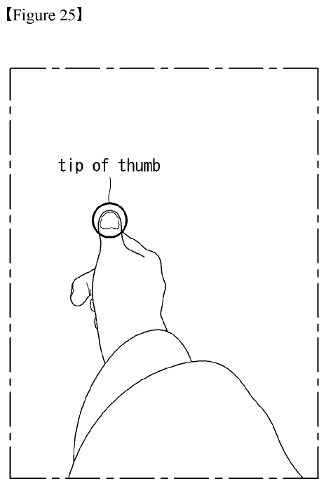

FIGS. 24 and 25 are views illustrating an additional embodiment of recognizing a position of a pointer.

As described above with reference to FIGS. 10 and 11, a position of the pointer corresponds to a position indicated by the index finger. However, the index finger may not be recognized in an image obtained using the image capturing unit 421 depending on a height at which the user's hand is located.

As shown in FIG. 24, if the index finger is not identified but a knuckle of the index finger is identified in the image, the controller 480 may use a position corresponding to the knuckle portion of the index finger as pointer coordinates.

As shown in FIG. 25, if not only the index finger but also even the knuckle of the index finger are not identified in the image, the controller 480 may use a position corresponding to a tip portion of the thumb as pointer coordinates.

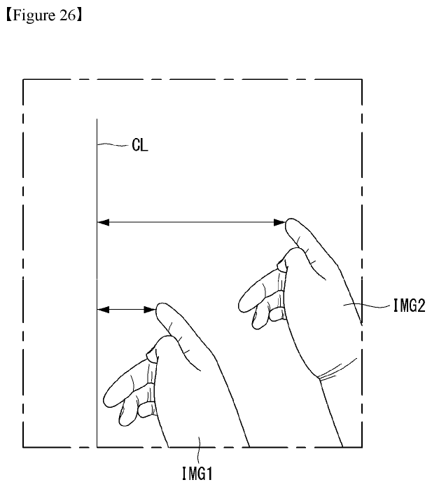

FIG. 26 is a view illustrating a method of obtaining motion information from an image including a plurality of hand images.

Referring to FIG. 26, a hand of someone else other than a user's hand may be identified in an image. Since the image capturing unit 421 is close to a body center of the user, a hand near a center line CL is regarded as the user's hand in a case where a plurality of hands are identified in the image. For example, if a first hand image IMG1 and a second hand image IMG2 are identified in the captured image as shown in FIG. 26, the controller 480 may obtain motion information on the basis of the first hand image IMG1 close to the center line CL.

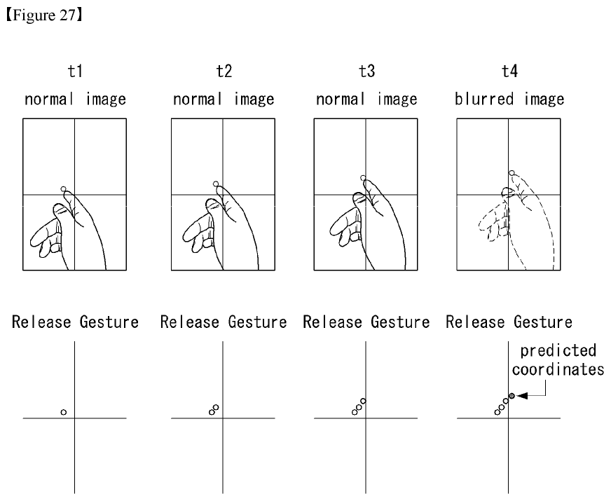

FIG. 27 is a view illustrating an embodiment of interpolating a blurred image when an image blur phenomenon occurs.

FIG. 27 shows images obtained through the image capturing unit 421 during a period from a first time point t1 to a fourth time point t4 and a pointer position at each time point.

Referring to FIG. 27, normal images are obtained from the first time point t1 to the third time point t3, based on which the position of the pointer may be displayed. If the image is blurred at the fourth time point t4, it is difficult to obtain motion information on the basis of the image. In this case, the controller 480 may calculate coordinates predicted by interpolating pointer coordinates obtained on the basis of the plurality of normal images before the blurred image, and display the pointer P at the predicted coordinates.

The components described herein should not to be construed as limiting in all aspects and should be considered as being exemplary. The scope of the present disclosure should be determined by rational interpretation of the appended claims, and all changes within the scope of equivalents of the present disclosure are included in the scope of the present disclosure.

1. A method of controlling an augmented reality (AR) electronic device worn on a head part of a user, provided with a virtual object from an application, and having an image capturing unit, the method comprising:
allocating a display area within a visual field of a user and displaying a virtual object in the display area;
obtaining motion information on the basis of a hand image of a user using an image capturing unit;
calculating coordinates of a pointer from the motion information and displaying the pointer in the display area; and
separately displaying a real object and a virtual object not to overlap each other if the pointer is located in an area where the real object and the virtual object overlap each other in the visual field of the user.

2. The method of claim 1, wherein
the separately displaying of a real object and a virtual object comprises displaying an emoticon or a user interface corresponding to the real object.

3. The method of claim 1, further comprising:
generating a predetermined event according to the motion information,
wherein the generating of a predetermined event comprises generating an idle event if a thumb and a middle finger are separated and a degree to which four fingers excluding the thumb are bent is less than a predetermined first threshold value in the motion information.

4. The method of claim 1, further comprising:
generating a predetermined event according to the motion information,
wherein the generating of a predetermined event comprises:
generating a first event if a thumb is in contact with a middle finger, a degree to which an index finger is bent is less than a predetermined first threshold value, and a degree to which a middle finger, a ring finger, and a little finger are bent is equal to or greater than the first threshold value in the motion information.

5. The method of claim 4, further comprising:
performing a motion corresponding to a mouse left click according to the first event.

6. The method of claim 5, wherein
the performing of a specific motion according to the first event comprises performing another motion depending on a position where the thumb is in contact with the middle finger.

7. The method of claim 1, further comprising:
generating a predetermined event according to the motion information,
wherein the generating of a predetermined event comprises:
generating a second event if a thumb and a middle finger are separated, a degree to which an index finger is less than a predetermined first threshold value, and a degree to which a middle finger, a ring finger and a little finger are bent is equal to or greater than the first threshold value in the motion information.

8. The method of claim 7, further comprising:
performing a motion corresponding to a mouse release according to a second event.

9. The method of claim 1, wherein
the obtaining of motion information comprises obtaining pointer coordinates corresponding to a predetermined specific position in the hand image.

10. The method of claim 1, further comprising:
displaying a user interface of a virtual object or a real object corresponding to a point indicated by the pointer.

11. The method of claim 10, further comprising:
generating a third event if a motion of the thumb sliding on the middle finger is identified in the first event state, in which the third event is performing a control operation of the user interface.

12. The method of claim 10, further comprising:
generating a fourth event if a motion of the index finger is identified in the first event state,
wherein the fourth event is performing a control operation of the user interface.

13. The method of claim 10, further comprising:
adding a feedback effect for enhancing visibility of the user interface indicated by the pointer.

14. The method of claim 10, wherein
the displaying of a pointer comprises sequentially varying a pointer position over time, and
if the hand image is blurred at a specific point of time, the pointer for the blurred hand image is displayed by interpolating the pointer position generated on the basis of a few or more previous time points.

15. The method of claim 1, further comprising:
receiving a downlink control information (DCI) used for scheduling transmission of the hand image from a network,
wherein the hand image information is transmitted to the network on the basis of the DCI.

16. The method of claim 15, further comprising:
performing an initial access procedure with the network on the basis of a synchronization signal block (SSB),
wherein the hand image information is transmitted to the network through a physical uplink shared channel (PUSCH) and the SSB and a demodulation reference signal (DM-RS) of the PUSCH are quasi-co-located, QCL, for a QCL type D.
